(19) United States
(12) Patent Application Publication
(10) Pub. No.: US 2012/0148779 A1
(43) Pub. Date: Jun. 14, 2012

(54) Integrated foam tape

(75) Inventors: Timothy F. O'Brien, White Lake, MI (US); Scott Mouser, Brampton (CA)

(73) Assignee: Magna International Inc., Aurora (CA)

(21) Appl. No.: 12/928,421

(22) Filed: Dec. 10, 2010

(51) Int. Cl. B32B 7/10; B32B 7/06; B32B 27/00; B32B 37/12; B32B 37/14

(52) U.S. Cl. 428/40.6; 156/306.6; 156/244.11; 156/245; 428/41.8; 428/41.3; 428/41.5; 428/304.4; 428/40.1; 428/316.6

(57) ABSTRACT

A part having foam tape integrated into a base component. The base component of the part is a body side molding which is attached to a vehicle using an adhesive. More specifically, the part includes a foam layer integrally formed with the body side molding such that a first side of the foam layer is formed with the body side molding, and an adhesive layer attached to a second side of the foam layer. A release film material is selectively attached to the adhesive layer such that the adhesive layer is disposed between the release film material and the foam layer. The release film material is able to be removed from the adhesive layer, and the body side molding is attached to a vehicle using the adhesive layer. The body side molding is used to protect the vehicle, as well as provide an improvement in the appearance of the vehicle.

### FIELD OF THE INVENTION

The present invention relates to a foam tape integrated into a base component, where the foam tape also includes an adhesive which facilitates the base component being connected to a second component.

### BACKGROUND OF THE INVENTION

Double-sided tape is a commonly used to connect various devices where other types of fasteners (such as a nut and bolt, welding, etc.) are not suitable. One type of double-sided tape is foam double-sided tape which typically consists of a first release film, a first adhesive layer, a foam layer, a second adhesive layer on the opposite side of the foam layer as the first adhesive layer, and a second release film on top of the second adhesive layer. However, this type of double-sided tape is costly due to there being two release films and two adhesive layers the foam layer.

Accordingly, there exists a need for an improvement in the use of double-sided tape as an adhesive for connecting to components together.

### SUMMARY OF THE INVENTION

The present invention is directed to a part having foam tape integrated into a base component. The base component of the part is a body side molding which is attached to a vehicle using an adhesive. More specifically, the part includes a foam layer integrally formed with the body side molding such that a first side of the foam layer is formed with the body side molding, and an adhesive layer attached to a second side of the foam layer. A release film material is selectively attached to the adhesive layer such that the adhesive layer is disposed between the release film material and the foam layer.

The release film material is able to be removed from the adhesive layer, and the body side molding is attached to a vehicle using the adhesive layer. The body side molding is used to protect the vehicle, as well as provide an improvement in the appearance of the vehicle. In one embodiment, the body side molding is made from polyvinyl chloride, polypropylene, or polyethylene, and the foam layer is made from a thermoplastic olefin, polyvinyl chloride, polypropylene, or polyethylene.

In one embodiment, the foam layer and the body side molding are integrally formed using a co-extrusion process. In another embodiment, the foam layer and the body side molding are integrally formed using a two-shot molding process.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional side view of a part having integrated foam tape, according to the present invention;

FIG. 2 is a perspective view of a vehicle having a part attached, with the part having integrated foam tape, according to the present invention; and

FIG. 3 is a perspective view of a part having integrated foam tape, according to the present invention.

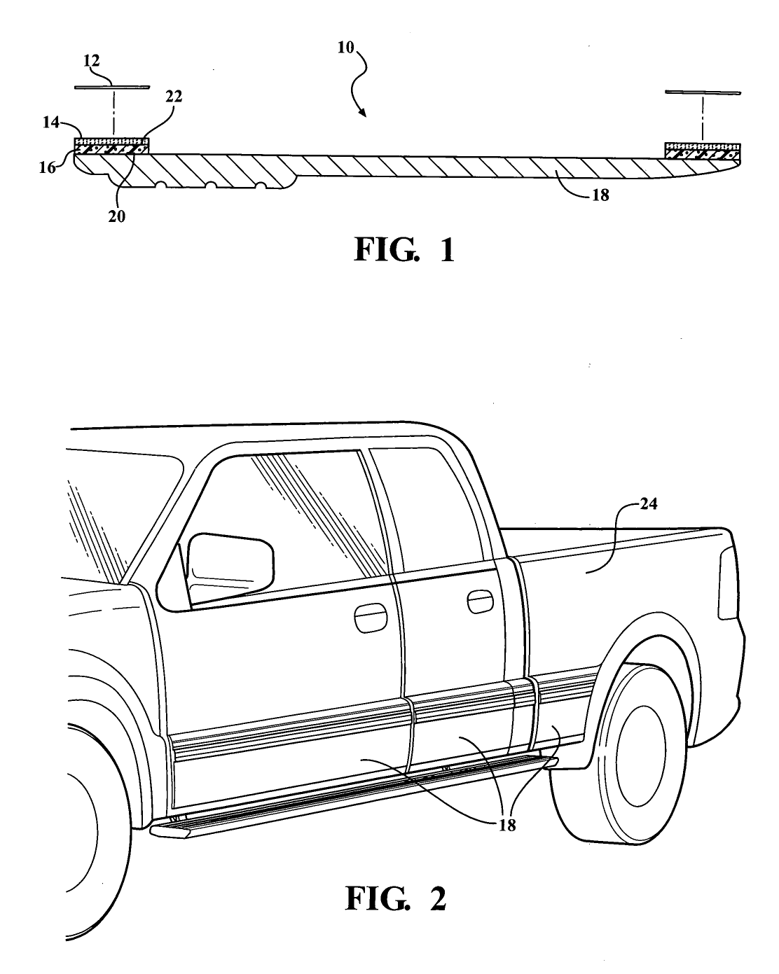

### DETAILED DESCRIPTION OF THE PREFERRED EMBODIMENTS

The following description of the preferred embodiment(s) is merely exemplary in nature and is in no way intended to limit the invention, its application, or uses.

An embodiment of a part having integrated foam tape according to the present invention is shown in the Figures generally at 10. The tape 10 is made up of one or more layers, and in this embodiment has two layers, a first layer 12, a second layer 14, and a third layer 16. The first layer 12 is a release film material, the second layer 14 is an adhesive layer, and the third layer 16 is a foam layer integrated into a base component 18.

The base component 18 is an extruded polyvinyl chloride (PVC) material, but it is within the scope of the invention that other thermoplastic polymers may be used, such as polypropylene and polyethylene. The foam layer 16 is made of a foam PVC, thermoplastic olefin (TPO), polypropylene, polyethylene, an acrylic foam tape, or other thermoplastic polymer suitable for being co-extruded with the material used for the base component 18. In alternate embodiments, any other type of material having a suitable durometer may be used instead of the foam layer 16. In this embodiment, the base component 18 is a body side molding for attachment to the side of a vehicle 24, however, it is within the scope of the invention that the integration of the foam layer 16 and the base component 18 may be applied to other objects as well. The base component 18 and the foam layer 16 are co-extruded together, and the adhesive 14 along with the release film material 12 are attached to the foam layer 16. More specifically, the base component 18 and the foam layer 16 are co-extruded such that a first side 20 of the foam layer 16 is integrated into the base component 18. After the base component 18 and the foam layer 16 are extruded together, the adhesive layer 14 is applied to a second side 22 of the foam layer 16, and the release film material 12 is applied to the adhesive layer 14 such that the adhesive layer 14 is between the release film material 12 and the foam layer 16, thereby forming a finished part.

Once completely assembled, the finished part may be transported where necessary to be installed. As mentioned above, the base component 18 in this embodiment is a body side molding. The body side molding 18 may be transported to another manufacturing facility, or to a different location within the same facility. Once it is desired to attach the finished part to a vehicle, the release film material 12 is simply peeled away from the adhesive layer 14, exposing the adhesive layer 14. The finished part is then placed in contact with the surface the vehicle 24 the body side molding 18 is to be attached to, an example of which is shown in FIG. 2.

The present invention provides the advantage where the adhesive layer 14 connects the body side molding 18 to the vehicle without any additional fasteners. Also, only one side of the foam layer 16 has the adhesive layer 14, therefore, having an adhesive layer is not needed on the first side 20 of the foam layer 16 to attach the foam layer 16 to the body side molding 18, since the foam layer 16 is integrated into the body side molding 18. Furthermore, using a co-extrusion process allows the body side molding 18 and foam layer 16 to be cut to different lengths, and used on different parts of the vehicle 24, such as the doors and quarter panels, best seen in FIG. 2.

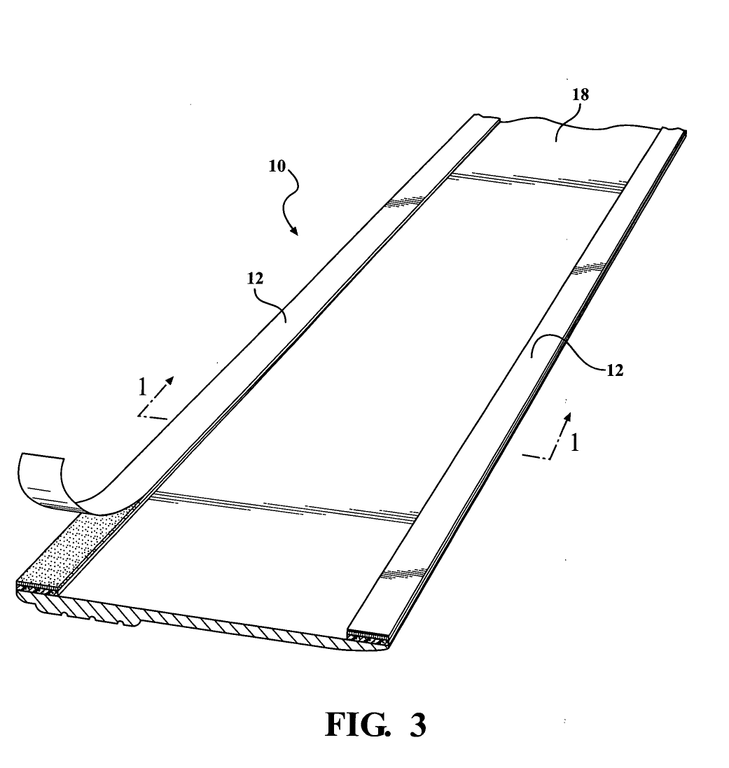

In this embodiment, there are two foam layers 16 integrally formed with the body side molding 18 along the outer edges of the body side molding 18, best shown in FIG. 3. However, it is within the scope of the invention that other configurations may be used such that other areas of the body side molding 18 may be covered by a larger or smaller area making up the foam layer 16.

In a second embodiment, a two-shot molding process is used to integrate the base component 18 and the foam layer 16 together, instead of co-extruding the base component 18 and the foam layer 16. The second embodiment involves injecting the PVC into the mold to form the base component 18, followed by injecting the material into the mold used to form the foam layer 16.

In a third embodiment, an over molding operation is used to integrate the base component 18 and the foam layer 16. In this process, two separate molds are used, the first mold is used to form the base component 18. The base component 18 is then removed from the first mold and placed into a second mold, where the foam layer 16 is molded to the base component 18.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A part having foam tape integrated into a base component, comprising:
a first layer;
a second layer, said first layer selectively attached to said second layer;
a third layer having a first side and a second side, said second layer attached to said second side of said third layer; and
a base component, said first side of said third layer integrally formed with said base component;
wherein said first layer is removed from said second layer such that said base component is connectable to a vehicle using said second layer.

2. The part having foam tape integrated into a base component of claim 1, wherein said body side molding and said third layer are integrally formed using a co-extrusion process.

3. The part having foam tape integrated into a base component of claim 1, wherein said body side molding and said third layer are integrally formed using two-shot molding process.

4. The part having foam tape integrated into a base component of claim 1, said first layer further comprising a release film material.

5. The part having foam tape integrated into a base component of claim 1, said second layer further comprising an adhesive layer.

6. The part having foam tape integrated into a base component of claim 1, said third layer further comprising a foam layer.

7. The part having foam tape integrated into a base component of claim 6, wherein said foam layer is made from one selected from the group consisting of a thermoplastic olefin, polyvinyl chloride, polypropylene, polyethylene, an acrylic foam tape, and combinations thereof.

8. The part having foam tape integrated into a base component of claim 1, wherein said body side molding is made from one selected from the group consisting of polyvinyl chloride, polypropylene, polyethylene, and combinations thereof.

9. A part having foam tape integrated into a base component, comprising:
a body side molding;
a foam layer integrally formed with said body side molding such that a first side of said foam layer is formed with said body side molding;
an adhesive layer attached to a second side of said foam layer; and
a release film material selectively attached to said adhesive layer such that said adhesive layer is disposed between said release film material and said foam layer;
wherein said release film material is operable to be removed from said adhesive layer, and said body side molding is attached to a vehicle using said adhesive layer.

10. The part having foam tape integrated into a base component of claim 9, wherein said body side molding and said foam layer are integrally formed using a co-extrusion process.

11. The part having foam tape integrated into a base component of claim 9, wherein said body side molding and said foam layer are integrally formed using two-shot molding process.

12. The part having foam tape integrated into a base component of claim 9, wherein said body side molding is made from one selected from the group consisting of polyvinyl chloride, polypropylene, polyethylene, and combinations thereof.

13. The part having foam tape integrated into a base component of claim 9, wherein said foam layer is made from one selected from the group consisting of a thermoplastic olefin, polyvinyl chloride, polypropylene, polyethylene, an acrylic foam tape, and combinations thereof.

14. A method for integrating a foam layer with a base component, comprising the steps of:
providing a body side molding;
providing a foam layer having a first side and a second side;
providing an adhesive layer; and
providing a release film material;
integrally forming said foam layer with said body side molding such that said first side is attached to said body side molding;
attaching said adhesive layer to said second side of said body side molding;
selectively attaching said release film material to said adhesive layer such that said adhesive layer is disposed between said release film material and said foam layer;
removing said release film material from said adhesive layer;
attaching said body side molding to a vehicle using said adhesive layer.

15. The method for integrating a foam layer with a base component of claim 14, further comprising the steps of integrally forming said foam layer and said body side molding by co-extruding said foam layer and said body side molding.

16. The method for integrating a foam layer with a base component of claim 14, further comprising the steps of:
injecting a first molten material into a mold, said first material used to form said body side molding; and
injecting a second molten material into said mold such that said second molten material integrally molds with said first molten material, said second molten material used to form said foam layer.

17. The method for integrating a foam layer with a base component of claim 16, further comprising the steps of providing said first molten material to be one selected from the group consisting of polyvinyl chloride, polypropylene, polyethylene, and combinations thereof.

18. The method for integrating a foam layer with a base component of claim 16, further comprising the steps of providing said second molten material to be one selected from the group consisting of a thermoplastic olefin, polyvinyl chloride, polypropylene, polyethylene, an acrylic foam tape, and combinations thereof.
